(19) United States
(12) Patent Application Publication
(10) Pub. No.: US 2019/0033440 A1
(43) Pub. Date: Jan. 31, 2019

(54) INTERFEROMETRIC MULTIPLE OBJECT TRACKING RADAR SYSTEM FOR PRECISION TIME SPACE POSITION INFORMATION DATA ACQUISITON

(71) Applicant: BAE Systems Technology Solutions & Services Inc., Rockville, MD (US)

(72) Inventors: Timothy BOOLOS, Mary Esther, FL (US); Michael KURECKI, Miramar Beach, FL (US); Ira EKHAUS, Arlington, MA (US)

(21) Appl. No.: 15/658,583

(22) Filed: Jul. 25, 2017

(51) Int. Cl. G01S 13/72; G01S 13/42

(52) U.S. Cl. CPC G01S 13/726; G01S 2013/0254; G01S 13/42

(57) ABSTRACT

The system and method of radar tracking using orthogonal interferometry for multiple object tracking and more particularly to the use of multiple, coordinated, scanning radar systems and orthogonal interferometry techniques to increase the precision and accuracy of time-space-position information (ISM in military airborne object testing applications.

### FIELD OF THE DISCLOSURE

The present disclosure relates to multiple object tracking and more particularly to the use of multiple, coordinated, electronic scanning radar systems and orthogonal interferometry techniques to increase the precision and accuracy of time-space-position information (TSPI) in military testing of airborne objects and vehicles.

### BACKGROUND OF THE DISCLOSURE

Test ranges require highly accurate time-space-position information (TSPI) for multiple airborne objects under test during a test mission. Range instrumentation radars typically deployed on air test ranges use conventional monopulse techniques and are generally limited to tracking one object. Standard phased array, radars can track multiple objects, but are limited in accuracy by the size, weight, and power considerations of the system. Typically, the precision and accuracy of TSPI measurements are increased as the distance between the measuring sensors (such as radar elements in a phased array) is increased. When this is done in a conventional phased array, the array grows by the square of the distance, thus proportionally increasing the size, the weight, and the power consumed by the large number of transmit/receive modules. These conventional methods increase the cost and complexity of the phased array through the growth in support systems needed to power, cool, and monitor the status of the system.

Wherefore it is an object of the present disclosure to overcome the above-mentioned shortcomings and drawbacks associated with the prior state-of-the-art radar tracking systems.

### SUMMARY OF THE DISCLOSURE

One aspect of the present disclosure is a system comprising three electronically steered multi-element antenna panels arranged so that there is a baseline difference of a wavelengths between the centers of the array, typically an isosceles triangle, where the distance n is selected to provide the required accuracy and precision, the arrays being tied together with a unique timing circuit to ensure that the beam of each array is steered to the same azimuthal and elevation coordinates in space simultaneously, each array comprising the same number of antenna elements, which number is determined by the maximum tracking range required tor use of the instrument. The transmit signal of the array can be any frequency within the element bandwidth and allows for the imposition of coded waveforms on the transmitted carrier frequency, which codes are subsequently decoded by the receive electronics of the array, allowing for processing of the received signals using conventional, non-conventional, and orthogonal interferometry techniques. The use of this type of array to trigger transponders by sending the same coded waveform simultaneously from each array as part of the transmit waveform coding string is a unique feature of the system of the present disclosure,

In one embodiment of the system, the set of three phased arrays is mounted on a building pointed in a single direction where the system performs a self-survey and self-calibration in order to record an actual position for which very accurate measurement reference is required, In this embodiment of the system the data provided is extremely accurate TSPI (Time Space Position Information) measurement of airborne objects.

In one embodiment of the system, the set of three phased arrays is mounted on multiple sides of a building providing coverage of multiple quadrants or multiple directions where the system performs a self-survey and self-calibration in order to record an actual position for which very accurate measurement reference is required. in this embodiment of the system, the data provided is extremely accurate TSPI (Time Space Position Information) measurement of airborne objects.

In one embodiment of the system, the set of three phased arrays is mounted on a positioner that can physically scan the array of the three phased arrays in any desired pair of azimuthal and elevation coordinates while physically mounted on a building in an area such as a roof-top or attached tower where the system performs a self-survey and self-calibration in order to record an actual position for which very accurate measurement reference is required, in this embodiment of the system the data provided is extremely accurate TSPI (Time Space Position Information) measurement of airborne objects.

In one embodiment of the system, the set of three phased arrays is mounted on a positioner that can physically scan the array of the three phased arrays in any desired pair of azimuthal and elevation coordinates while physically mounted on a trailer or motorized vehicle that can be driven to any physical point on land, where the system performs a self-survey and self-calibration in order to record an actual position for which very accurate measurement reference is required. In this embodiment of the system the data provided is extremely accurate TSPI (Time Space Position Information) measurement of airborne objects.

In one embodiment of the system, the set of three phased arrays is mounted on a positioner that can physically scan the array of the three phased arrays in any desired pair of azimuthal and elevation coordinates while physically mounted on a trailer or motorized vehicle that can be driven on to a barge mounted to go to sea where the system performs a self-survey, self-calibration, and motion compensation in order to record an actual position for which very accurate measurement reference is required. In this embodiment of the system the data provided is extremely accurate TSPI (Time Space Position Information) measurement of airborne objects.

In one embodiment of the system, the set of three phased arrays is mounted on a positioner that can physically scan the array of the three phased arrays in any desired pair of azimuthal and elevation coordinates while physically mounted on an ocean--going vessel where the system performs a self-survey, self-calibration and motion compensation in order to record an actual position for which very accurate measurement reference is required, In this embodiment of the system the data provided is extremely accurate TSPI (Time Space Position Information) measurement of airborne objects.

For all of the previous embodiments where the frequency of the phased arrays is within the UHF-Band of Frequencies. All of the previous embodiments where the frequency of the phased arrays is within the L-Band of Frequencies, All of the previous embodiments where the frequency of the phased arrays is within the S-Band of Frequencies, All of the previous embodiments where the frequency of the phased arrays is within the C-Band of Frequencies. All of the previous embodiments where the frequency of the phased arrays is within the X-Band of Frequencies. All of the previous embodiments where the frequency of the phased arrays is within the Kμ-Band of Frequencies. All of the previous embodiments where the frequency of the phased arrays is within the Millimeter-Band of Frequencies.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 shows one embodiment of a trailer mounted active electronically scanned array (AESA) radar system of the present disclosure in a deployed position.

FIG. 2 shows one embodiment of an orthogonal interferometer implemented with AESAs according to the principles of the present disclosure.

FIG. 3 shows a schematic view of one embodiment of a subarray assembly for use in an orthogonal interferometer according to the principles of the present disclosure.

FIG. 4 shows one example of positional accuracy enhancement provided by one embodiment of the active electronically scanned array (AESA) radar system of the present disclosure.

FIG. 5A shows one embodiment of a trailer mounted active electronically scanned array (AESA) radar system of the present disclosure in a stowed or travel position.

FIG. 5B shows one embodiment of a trailer mounted active electronically scanned array (AESA) radar system of the present disclosure in a first position where the pedestal has pivoted into an upright position.

FIG. 5C shows one embodiment of a trailer mounted active electronically scanned array (AESA) radar system of the present disclosure in a second position where the arrays have unfolded to prepare of use.

### DETAILED DESCRIPTION OF THE DISCLOSURE

It has been recognized that there is a need for an accurate radar TSPI system for use with multiple object tracking that minimizes the size, weight, cost, and power consumption of the tracking system. In one embodiment of the present disclosure, the system decouples the power requirements of the system from the accuracy requirements of the system by using several individual scanning radar arrays that are spaced apart with no intermediate arrays. In certain embodiments, arranging several three phased array antennas on a rotating platform, interferometric measurements of TSPI on multiple targets can be accomplished during a data acquisition mission.

US. Pat. No, 8,854,252 describes the use of orthogonal interferometry (OI) in bi-static and multi-static systems, particularly pairs of transmitters and receivers working with reflections off targets. This disclosure extends to use of interferometric radar systems to allow the triggering and tracking of transponder beacons which are used extensively on test ranges in the USA and world-wide. In certain embodiments, the system of this disclosure will use orthogonal interferometry, conventional interferometry, and monopulse techniques to provide the highly accurate and ambiguity resolved TSPI data.

In contrast to the static systems, there is no reflective surface in the system of the present disclosure. Instead, OI coding is used to map a field of regard and “track” multiple targets using the combination of active electronically scanned array (AESA) beam steering and pedestal movement.

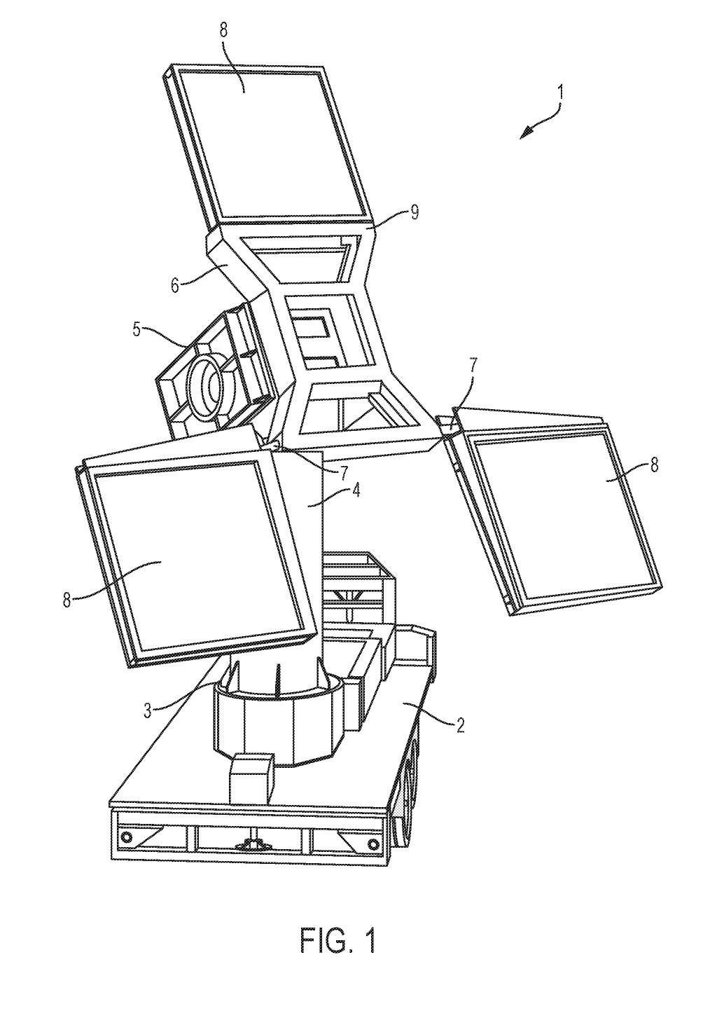

Referring to FIG. 1, one embodiment of a trailer-mounted, active electronically scanned array (AESA) radar system of the present disclosure in a deployed position is shown. More particularly, in one embodiment, an X-Band AESA based orthogonal interferometer (OI) is used. Each long range radar component in the system is comprised of a trailer 2 with a pedestal-mounted 4 grid 6 comprising three transmit/receive (Tx/Rx) planar radar arrays 8. In some cases, the pedestal 4 is similar to pedestals used to adjust the large parabolic dish radars, that are customized for the load and signals used.

Still referring to FIG. 1, the pedestal 4 is mounted into a base 3. In certain embodiments, the pedestal 4 folds down onto the trailer 2 and pivots at the base 3. In certain embodiments of the active electronically scanned array (AESA) radar system of the present disclosure the radar arrays 8 pivots along joints 7, 9 to pack more compactly when in transit. The grid 6 comprising three transmit/receive (Tx/Rx) planar radar arrays 8 is mounted to an azimuth/elevation positioner 5.

In certain embodiments, a modular subarray approach is used to build low-cost phased arrays. In some cases large 8′×9 ′ arrays are comprised of 36 modular 1′×2′ planar subarrays. These planar subarrays may have multiple elements (e.g., 32 elements) and contain an integrated radome, radiating elements, RF electronics, digital control electronics, power supplies, and other components. The modular subarray approach allows larger and smaller arrays to be fabricated using an identical subarray module, In one such embodiment, twenty four subarrays, each comprising 18×12 elements, are used to form a 5184 element array 8. Three of these arrays 8 are then mounted to a grid 6 to complete one pedestal-mounted, orthogonal interferometer component 1 according to the present disclosure.

In some cases, the radar backend will be implemented in X-Band. In other cases, the radar backend will be implemented in C-band. In yet other embodiments, L, S, and higher frequency hands may be used. L-Band is used when extremely long range and high altitude targets are to be tested because atmospheric attenuation of the radar signal is much less than other frequency hands, however they are extremely large compared to radars operating in the other frequency bands and so are most often utilized in a fixed embodiment such as mounted to the side of a building, discrete phase sifting components are most often used instead of Monolithic Microwave Integrated Circuits (MMICS) because of the wavelength size at L-Band, S-Band is a shorter wavelength than L-Band so the Radar is more readily adapted to embodiments that require azimuth and elevation positioning, S-Band components are smaller than L-Band components and MMICS can be used if chosen carefully. The S-band is more susceptible to weather but can be a good long range system. C-Band has a still shorter wavelength and the majority of transponders in use on military test ranges are in this hand which makes the Beacon Triggering Feature of the system of the present disclosure much more useful to the tester. MMICS and small RF components are readily available as many of the older monopulse based test radars are in this frequency band. In C-Band, the antenna size is smaller than L or S and can be mobilized for rapid relocation across the test ranges. X-Band is also often used on military test ranges. Small RF components and MMICs are most available in this radar frequency band, the small wavelength allows for smaller phased array antennas which are readily positioned and mobilized, however atmospheric attenuation limits the range of radars in this band. Kμ band radars are mostly suitable to shorter range radar tests due to the added atmospheric attenuation, but antennas and MMICS can be extremely small compared to the other radar bands.

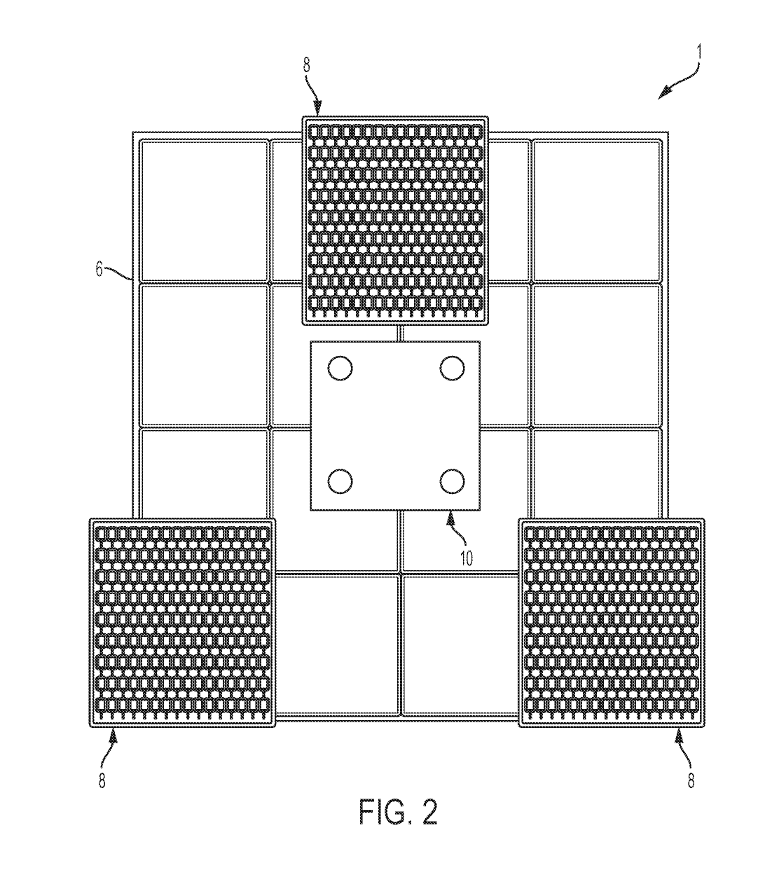

Referring to FIG. 2, one embodiment of an orthogonal interferometer implemented with AESAs according to the principles of the present disclosure is shown. More particularly, a triad of AESAs 8 are mounted to a frame or grid 6 to form an orthogonal interferometer component 1 that will be mounted to a pedestal on a vehicle (not shown). The pedestal points at the target of interest while the AESAs conduct synchronous scans (i.e. all 3 beams are pointed at the same point in space) to points referenced to the normal point. The mounting plate 10 is the mechanical connection device for mounting the array of AESAs to the positioner which moves the array in azimuth and elevation. This provides the reference point, or array normal from which the beam pointing angle is referenced to the array pointing angle. The mounting frame 6 allows arrays to be spaced so that the AESA are held at a wavelengths apart in the x and y linear dimensions, also known as the interferometric baseline.

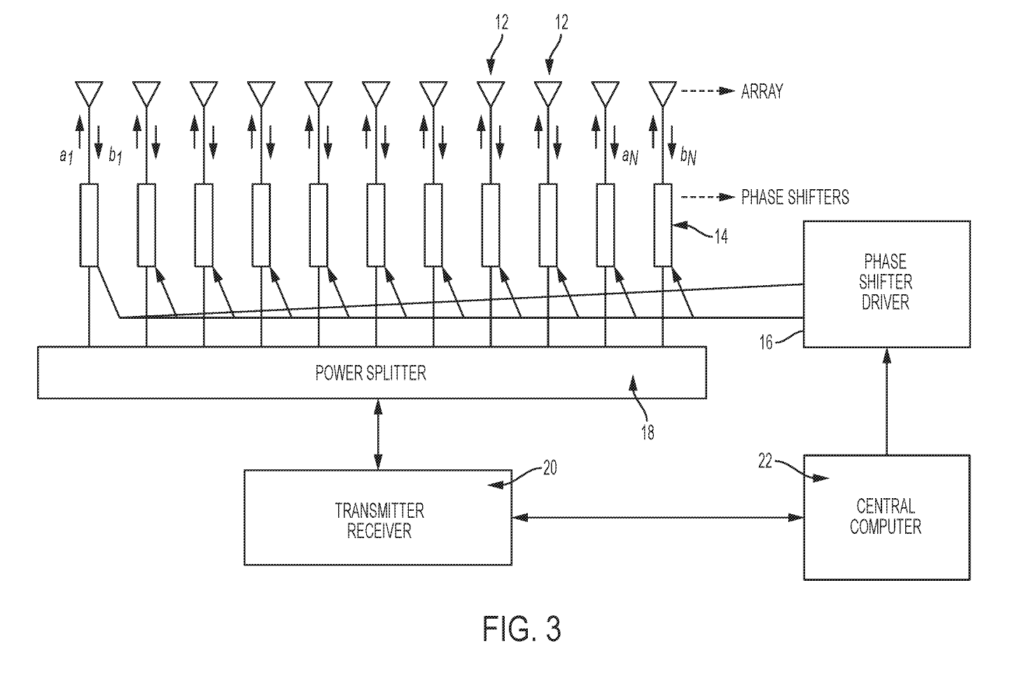

Referring to FIG. 3, a schematic view of one embodiment of a subarray assembly for use in an orthogonal interferometer component according to the principles of the present disclosure is shown. More particularly, one embodiment of the subarray is a multi-layer printed circuit board that contains RF, power, and control functions required in the subarray. The radiating element is typically included on one side of the board and the parts are mounted on the opposite side. These boards typically contain the Tx/Rx, modules, RF combining and distribution networks, power distribution networks, control networks, and RF interfaces to the full array.

This modular subarray serves as a line replaceable unit (LRU) in the system allowing for short mean time to repair (MTTR). The subarray is typically designed to survive the relevant environment, but can also be installed behind a radome or in a larger enclosure, if desired. This design approach is useful for naval, ground fixed, ground mobile, airborne, and space applications, with the specific packaging requirements tailored for the application.

Still referring to FIG. 3, in certain embodiments a central computer 22 is configured to control a transmitter receiver module 20. In some cases, the central computer 22 is configured to control a phase shift driver module 16. The phase shift driver module interacts with a plurality of phase shifters 14 coupled to corresponding elements 12 in the array. Each of the plurality of phase shifters 14 are coupled to a power splitter module 18. In the case of this system in addition to setting the appropriate phase shifter values to position the phased array antenna beam to the desired location in space the central computer imposes the required Orthogonal coding wave forms to enable the use of orthogonal interferometry. These codes are transmitted by each of the phased arrays of and then the received signals are deinterleaved based on the imposed code by the central computer. The transmit coding and receive coding are done simultaneously and the central computer controls the processes and ensures that the pulses are tagged and sorted according to the code in order to match them to the transmitted signal time and sequence.

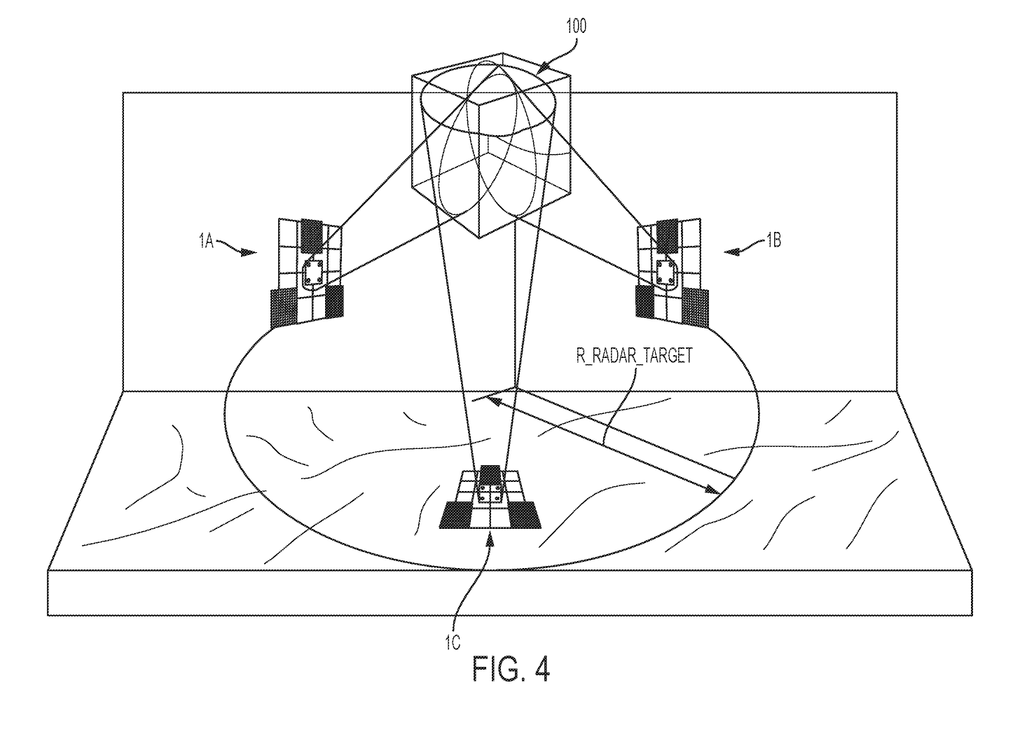

Referring to FIG. 4, one example of positional accuracy enhancement provided by one embodiment of the active electronically scanned array (AESA) radar system of the present disclosure is shown. More particularly, a simple triangulation scheme is shown, This type of processing is affected by geometric dilution of precision (GDOP), glint, scintillation and other phenomenon, but in this way parameters such as miss distance of targets can be very precisely measured. This method is improved using mobile and positionable orthogonal interferometers, where the precision and accuracy developed at the array face and within the radar can be further enhanced by the processing at the radar operations center (ROC).

In one embodiment, truck-mounted AESAs observed all of the multiple targets in a test run. Blind spot resolution, deviations from mission parameters, and general safety concerns suggested the need for multiple redundant observations of each airborne target. Particularly for ranges near populated areas, conducting live fire or even dummy testing being tracked and updated with non-lethal systems, the requirement for multiply redundant observations is expected. In many cases, a FOR of ±30° is recommended. This allows radars in the proper emplacement to observe the entire scenario using only electronic beam steering so that they can quickly pick up dropped tracks from other radar.

The positional accuracy enhancement provided by one embodiment of the active electronically scanned array (AESA) radar system of the present disclosure has a FOR of ±30°, which allowed radar in the proper emplacement to observe an entire scenario using only electronic beam steering. Reconfiguration of these systems for different missions was easily accomplished. The AESAs with only electronic beam steering were easy to maintain, since there are no moving parts and therefore fewer parts to break during a mission. Electronic beam steering and detection algorithms give the highest probability of accurate track initiation.

In contrast, fixed emplacements, no matter how mobile, limit the scope of the objects that are tracked during a live test. Essentially once emplaced, the fixed system may have difficulty dealing with unexpected target behavior that occurs at the limits of the coverage. Further changes that occur during a test could be difficult to respond to if they occur near the edges of the FOR and off boresight calibration would be required.

A positioner-mounted AESA system can be moved precisely in Azimuth and Elevation and respond to instant by instant changes in the test scenario. A positioner mounted array gives a larger coverage area to the range operator for the same FOR of the radar. When multiple missions are to be covered without attending or moving the radar, the positioner mounted system is less mission dependent in its placement. Optics are integrated more easily which gives an additional flexibility in the case where RF tracking becomes difficult or disadvantageous. The current standard for tracking Multiple Objects with a Range Instrumentation Radar, currently delivers 100 μRad accuracy when properly calibrated.

However, positioner mounted arrays are more costly to acquire and they are theoretically more costly to maintain over the lifetime of the system, since they include moving parts. Calibration takes longer and is more complex since non-orthogonalities, mislevel, solar and wind effects, etc. have to be calibrated often. These same calibration items are additional error sources that could reduce accuracy and require a robust calibration scheme to ensure accuracy over time.

Elimination of the positioner alleviates a lot of hardware, corresponding weight and maintenance. The slip ring, servo drive motors, mechanical gear boxes, high power servo amplifiers, low level servo chassis, pedestal brakes, azimuth and elevation bearings, pedestal axis position encoders and a multitude of power supplies are all eliminated as sources of potential problems when a fixed beam steered only solution is chosen, as is described herein.

In certain embodiments, the system comprises radar that uses OI techniques to realize a product that is mobile and self-contained (i.e. folds up a specific way and stows the radar on a truck bed that can be driven to the site of the test), in order to make the system self-contained and adhere to size constraints related to transport over both public roads and unimproved roads on military test ranges, the system folds the panels so that they lay flat against the positioner head and the positioning pedestal folds back into the truck or mobilizer bed. The system then uses hydraulics or other mechanical means to automatically deploy the pedestal and then the array panels into the configuration used for testing.

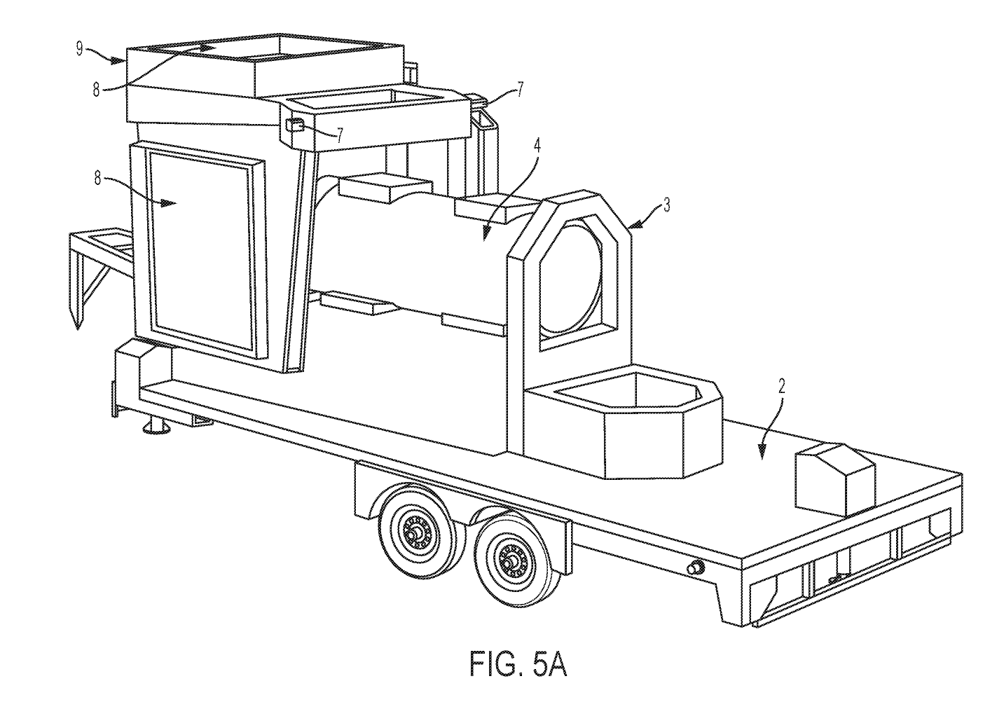

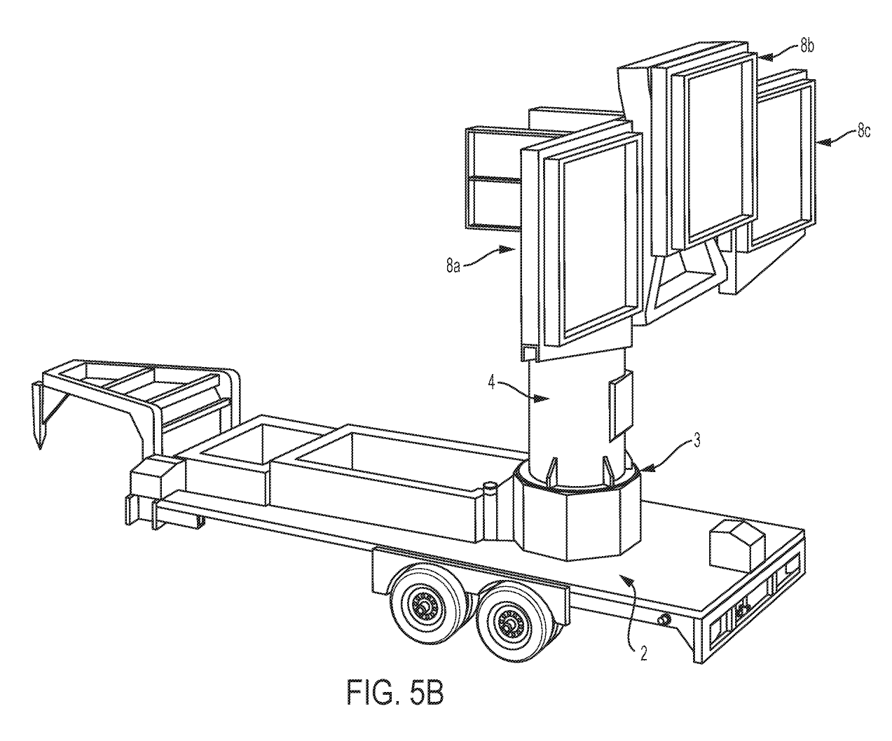

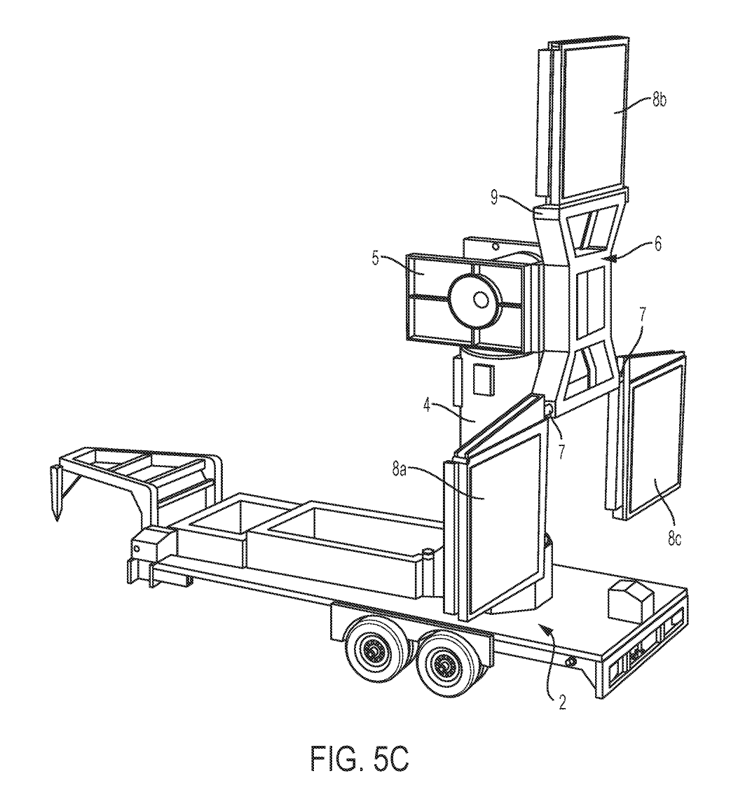

Referring to FIG. 5A, one embodiment of a trailer mounted active electronically scanned array (AESA) radar system of the present disclosure in a stowed or travel position is shown. More specifically, the pedestal 4 can be seen laying on the trailer 2 and the subarrays 8 can be seen folded in to face the interior of the apparatus such that the face of the arrays are not exposed in the stowed or travel position. There, the joints 7, 9 have been utilized to fold the array faces in. The pedestal base 3 has pivoted to allow the pedestal to lie on the trailer.

Referring to FIG. 5B, one embodiment of a trailer mounted active electronically scanned array (AESA) radar system of the present disclosure in a first position where the pedestal has pivoted into an upright position is shown. More specifically, the pedestal 4 has pivoted about the base 3 and is now in an upright position that is perpendicular to the trailer 2. Three subarrays 8a, 8b, and 8c have the back surfaces displaying out. Here, two of the sub arrays 8a, 8c pivoted about joints 7 to arrive in the same plane with the third subarray 8b.

Referring to FIG. 5C, one embodiment of a trailer mounted active electronically scanned array (AESA) radar system of the present disclosure in a second position where the arrays have unfolded to prepare of use is shown. More specifically, two of the arrays 8a, 8c have pivoted about joint 7 downwardly to expose the array face and the third array 8c has pivoted upwardly about joint 9 to expose the array face. Prior to pivoting, the array face of 8c was proximal to the grid 6 mounted to an azimuth/elevation positioner 5.

In some cases, the system of the present disclosure tracks multiple objects using both beam steering and movement in azimuth and elevation of the radar. The system tracks, moves positioner based on a single object or the centroid of a duster of objects, while scanning beam in azimuth and elevation to provide tracking data for any other objects in the (moving) field of regard.

In certain embodiments, the system of the present disclosure provides a specific level of accuracy based on the baseline distance between the radar antennas, which is a suitable level of accuracy for Test and Evaluation Ranges. Target accuracy is 0.1 mil, note pointing error compared with optical field of view. For a conventional Interferometer the angle to the target referenced to the normal of the array is given by the equation:

θ=sin⁻¹ (∅measured×λ2÷(2πD))

for Orthogonal Interferometer a code is used in the transmit waveforms that allows “D” the interferometer's baseline length (n wavelengths) to appear to the radar measured phase to be twice as long and thus allow the angle θ to be determined to a higher degree of precision and accuracy which can be expressed as θOrthogonal=sin⁻¹ (∅measured×λ÷(4πD)). Alternatively it can be seen that the design of the system allows for the use of a shorter baseline than in conventional interferometry to achieve the same level of accuracy,

In some embodiments, the system is composed of three AESA radar panels and scans and tracks objects within a ±30 degree field of regard in azimuth and elevation (0 Az, 0 El is defined with respect to the face of the array for field of regard). In some cases, the use state of art array design and a minimum field of regard is determined by the number and arrangement of array elements, The field of regard achieved by the system can be custom designed subject to the limits on beam performance inherent in scanning a beam off normal to the extremes of the field of regard. Typically the maximum extent to which beams can be steered off normal of the array is ±60 degrees (in either elevation or azimuth) due to the reduction in gain and increase in the beamwidth of the beam which varies as the sine of the steered angle.

In certain embodiments, the system of the present disclosure triggers radar beacons on U. S. Military test ranges. On these test ranges Beacons are used to assist radar detection of targets by echoing the received radar pulse and amplifying it so that the radar track is localized to the beacon transmission point from the airborne object under test. Beacons are defined by Range Commanders Council Standard 262-14 C (G)-BAND & X (I)—BAND NONCOHERENT RADAR TRANSPONDER PERFORMANCE SPECIFICATION STANDARD. The present disclosure describes a system that allows an interferometric radar system to trigger beacons in addition to tracking skin returns of targets of interest. In particular the C-Band embodiment of this invention allows the system to trigger beacons to the RCC 262-14 standard as well as track the RADCAL (radar calibration) satellite which was launched in 1993 to enhance radar test and calibration capabilities and is relied upon by the military test ranges as a truth source of extraordinary precision to calibrate the test measurements.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure, Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skiff in the art are considered to be within the scope of the present disclosure.

What is claimed:

1. A multiple object radar tracking system, comprising
an orthogonal interferometer having an azimuthal and an elevation positioning system and at least three phased array antennas that transmit and receive pulsed waveforms at the frequency of the array; and
a computer system used to control the radar and positioning system.

2. The radar tracking system of claim 1, wherein the radar tracking system is mounted in a fixed site infrastructure such as a building or tower.

3. The radar tracking system of claim 1, wherein the radar tracking system is mounted onto a transporter that moves the radar tracking system to a location of interest. The radar tracking system of claim 1, wherein the radar tracking system is mounted onto the bed of a truck that moves the radar to a location of interest. The radar tracking system of claim 1, wherein the radar tracking system is moved aboard a waterborne vessel and used to track from the water.

6. The radar tracking system of claim 1, wherein the radar tracking system operates in S-Band of RF Frequencies.

7. The radar tracking system of claim 1, wherein the radar tracking system operates in C-Band of RF Frequencies.

8. The radar tracking system of claim 1, wherein the radar tracking system operates in X-Band of RF Frequencies.

9. The radar tracking system of claim 1, wherein the radar tracking system operates in Kμ-Band of RF Frequencies.
